(19) United States
(12) Patent Application Publication
(10) Pub. No.: US 2004/0198294 A1
(43) Pub. Date: Oct. 7, 2004

(54) Apparatus and method of transmission link quality indicator

(76) Inventor: Tsofnat Hagin-Metzer, Nes-Ziona (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/133,629

(22) Filed: Apr. 29, 2002

(51) Int. Cl. H04B 1/10

(52) U.S. Cl. 455/296; 455/67.16

(57) ABSTRACT

Briefly, a portable communication device that is able to block transmission of a link quality indicator is provided. The transmission of the link quality indicator may be blocked if the quality level of a channel is below or at a threshold. The threshold may be generated according to a target quality level.

### BACKGROUND OF THE INVENTION

In wireless communication systems, for example a cellular communication system such as Wideband Code Division Multiple Access (WCDMA), a link quality indicator may be used. For example, the link quality indicator may be used to control transmission over a high-speed shared channel.

The link quality indicator may be transmitted from user equipment (UE), for example, a mobile station to a base station (which may known to one skilled in the art of WCDMA as Node B). For example, in a WCDMA cellular communication system, the link quality indicator may be transmitted periodically, from UE to Node B, at predetermined time slots. The transmission of the link quality indicator may increase the power consumption of the UE. Thus, there may be degradation in the lifetime of a battery of the UE. Furthermore, transmissions of link quality indication may result in interference noise to other UEs.

Thus, there is a need for a better way to reduce the power consumption of UE.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a block diagram of a wireless communication system, according to an embodiment of the present invention;

FIG. 2 is a block diagram of a mobile communication user equipment, according to an alternative embodiment of the present invention; and

FIG. 3 is a flow chart of a method according to an embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

It should be understood that the present invention may be used in a variety of applications. Although the present invention is not limited in this respect, the circuits and techniques disclosed herein may be used in many apparatuses such as transmitters of a radio system. Portable communication devices intended to be included within the scope of the present invention may include, by a way of example only, cellular radiotelephone portable communication devices, digital communication system portable devices and the like.

Types of cellular radiotelephone systems intended to be within the scope of the present invention include, although are not limited to, Code Division Multiple Access (CDMA) and WCDMA cellular radiotelephone portable devices for transmitting and receiving spread spectrum signals, Global System for Mobile communication (GSM) cellular radiotelephone, Time Division Multiple Access (TDMA), Extended-TDMA (E-TDMA), General Packet Radio Service (GPRS), Extended GPRS, and the like.

For simplicity, although the scope of the invention is in no way limited in this respect, embodiments of the present that will be described below may be related to a WCDMA cellular radiotelephone system. The term “plurality” may be used throughout the specification to describe two or more components, devices, elements, parameters and the like. For example, “plurality of mobile stations” describes two or more mobile stations. In addition, it should be known to one skilled in the art that the term “a portable communication device” may refer to, but is not limited to, a mobile station, a portable radiotelephone device, a cell-phone, a cellular device, personal computer, Personal Digital Assistant (PDA), user equipment and the like.

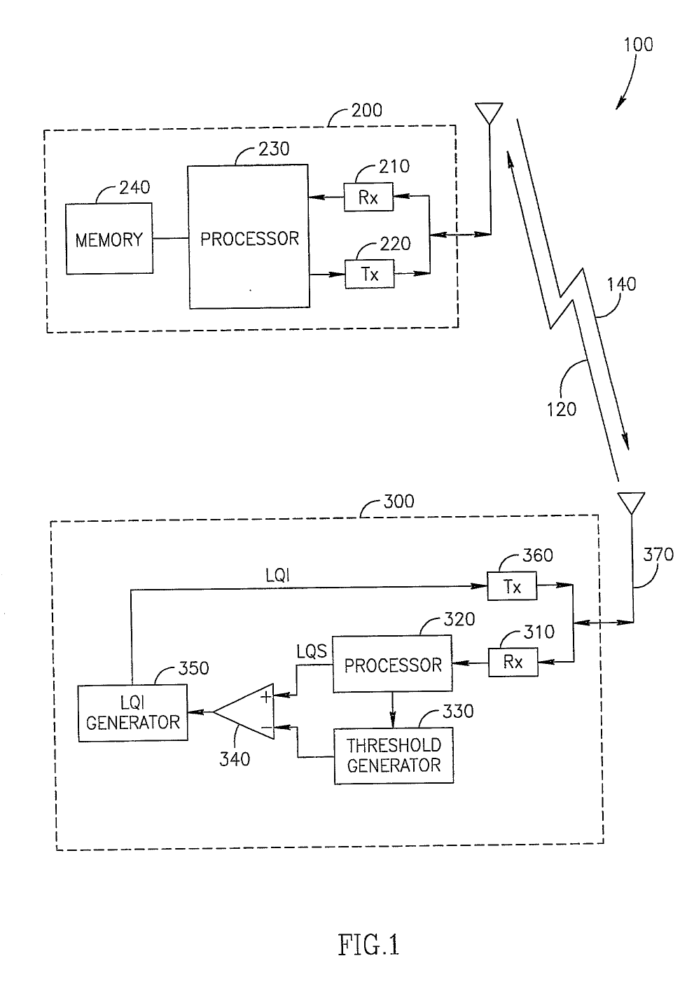

Referring firstly to FIG. 1, a block diagram of a wireless communication system 100 according to some embodiments of the present invention is shown. Wireless communication system 100 may include a base station or a plurality of base stations, and a mobile station or a plurality of mobile stations. For simplicity, a base station 200 and a mobile station 300 are shown. Although the scope of the present invention is not limited in this respect, base station 200 may include a transmitter 220, a receiver 210, and a processor 230 to generate a signal indicating a link quality threshold. In addition, mobile station 300 may include a receiver 310, a processor 320, a threshold generator 330 to generate a threshold signal, a comparator 340, a generator 350 to generate a link quality indicator and a transmitter 360.

Although the scope of the present invention is not limited in this respect, links, such as for example, an uplink and a downlink, may be used to transfer communications from base station 200 to mobile station 300 and vice versa. An uplink 120 may transfer communications from mobile station 300 to base station 200, and a downlink 140 may transfer communications from base station 200 to mobile station 300. Additionally, uplink 120 and downlink 140 may include one or more channels. Channels may be used for voice and data transportation. For example, in cellular communication systems there may be two types of channels. The first type of channels may be common channels and the second type may be dedicated channels. Although, the scope of the present invention is not limited in this respect, the common channels may be used to carry data for users and the dedicated channels may be used to carry data and voice that is addressed to a specific user.

Types of channels may be pilot channels (CPICH), random access channels (PRACH), packet channels (PCPCH) and the like. More particularly, types of WCDMA channels may be, for example, uplink dedicated channels such as Dedicated Physical Data Channel (DPDCH) and Dedicated Physical Control Channel (DPCCH) and the like; uplink common channels such as Physical Random Access Channel (PRACH), Physical Common Packet Channel (PCPCH) and the like; downlink dedicated channels such as Downlink Dedicated Physical Channel (DPCH) and the like; and downlink common channels such as Common Pilot Channel (CPICH), Primary Common Pilot Channel (P-CPICH), Secondary Common Pilot Channel (S-CPICH), Primary Common Control Physical Channel (P-CCPCH), Secondary Common Control Physical Channel (S-CCPCH), Synchronization Channel (SCH), Physical Downlink Shared Channel (PDSCH), Acquisition Indicator Channel (AICH), Access Preamble Acquisition Indicator Channel (AP-AICH), Collision Detection/Channel Assignment Indicator Channel (CD/CA-ICH), Paging Indicator Channel (PICH), Status Indicator Channel (CSICH) and the like, although the scope of the invention is not limited in this respect.

Although the scope of the present invention is not limited in this respect, the channel quality may be characterized by, for example a block error rate (BLER), a signal interference ratio (SIR), a signal to noise ratio (SNR) and the like. For example, the SIR may be described by equation 1:

SIR=(RSCP/ISCP)×SF Equation 1;

where

RSCP may be a received signal code power;

ISCP may be an interference signal code power; and

SP may be the Spreading Factor.

Furthermore, the SNR may be described by equation 2:

SNR=RSCP/RSSI Equation 2;

wherein

RSSI may be the received signal strength indicator.

In addition, the BLER may estimated, for example, by dividing the number of received transport blocks with a cyclic redundancy check (CRC) error during the measurement period by the number of received transport blocks during the same measurement period.

Those characteristics and others may be used to provide an indication about the quality of the link. The indication about the link quality (downlink or uplink) may be used, for example, to choose which user of mobile station may be served over a shared channel, to set the coding and modulating scheme, to set the transport block size and to set the resource allocation.

Furthermore, a link quality indicator (LQI) may be generated according to measurements and/or estimations of the above-described characteristics. In addition, in alternative embodiments of the present invention, the LQI that generated for one channel such as PDSCH, may be generated based on measurements that are performed on a different channel, such as the CPICH or S-CPICH. In addition, LQI may also include or consist solely of, a request for parameters to control data and voice transportation within the channels according to the quality of the channel.

Although the scope of the present invention is not limited in this respect, in operation, a portable communication device, for example mobile station 300, may receive a signal transmitted by base station 200 over downlink 140 with antenna 370. In embodiments of the present invention antenna 370 may be a dipole antenna, shot antenna and the like. A downlink pilot channel for example, P-CPICH or S-CPICH and the like may provide the received signal. Receiver 310 may demodulate the received signal to provide a demodulated signal to processor 320. For example, receiver 310 may include a baseband module, a rake receiver, a demodulator (not shown) and the like, which may be used to demodulate the received signal. Furthermore, in alternative embodiments of the present invention, for example, GSM receivers, other methods or processes may be used to demodulate the received signal. Furthermore, the demodulated received signals may include characteristics, for example Carrier to interference ratio (CIR), which may be used by processor 320 to measure and/or estimate the quality of the channel.

Although the scope of the present invention is not limited in this respect, processor 320 may be a digital signal processor (DSP), a reduced instruction set computer (RISC) processor, a microprocessor, a micro-controller, a custom integrated circuit to perform a predefined algorithm and/or method and the like.

Processor 320 may use methods and/or algorithms to perform measurements and/or estimations of the quality of the channel. For example, one method may be to measure and/or to estimate the BLER by calculating the ratio between the number of blocks with CRC errors and the total number of blocks that were received during the measurement period. Another method may be to measure and/or to estimate the SIR with equation 1. Furthermore, a method that measures and/or estimates the signal to noise ratio (SNR) may also be used to generate a link quality signal (LQS), if desired. The method may measure the SNR by measuring the noise level of the received signal. However, it should be understood to the one skilled in the art, that the methods and/or algorithms that where are described-above are examples only. Other methods, algorithms and other characteristics which may be used with the methods and algorithms may be used to generate the LQS, if desired.

Although the scope of the present invention is not limited in this respect, the LQS may be compared by comparator 340 to a threshold. In some embodiments of the present invention, comparator 340 may block the generation and the transmission of the LQI if the LQS level is below or equal to the threshold. Types of comparators that may be used with embodiments of the present invention may include analog comparators, digital comparators, comparators with hysteresis, a function of the processor 320 that may compare two values and provide an output resulting from the comparison, and the like.

Although the scope of the present invention is not limited in this respect, in some embodiments of the present invention, the threshold may be a predetermined level. However, threshold generator 330 may generate a threshold level according to the measured or estimated parameters that may indicate the quality of one or more selected channels, for example a pilot channel. In addition, generator 330 may receive the LQS level from processor 320 and generate a threshold accordingly. For example, the threshold may be a percentage of the average level of measurements or estimations of the characteristics that may indicate the quality level of the received channel. In addition, the threshold may be set according the quality of a required service, for example, resource allocation, short message service (SMS) and the like. The service may be provided over the shared channel, for example PDSCH. However, other methods to generate the threshold level may be used, if desired.

As described above, comparator 340 may block or enable the transmission of the LQI. Furthermore, in this embodiment of the present invention, comparator 340 may block or enable the generation of the LQI. For example, for an LQS level above the threshold, comparator 340 may enable the generation of the LQI by generator 350. For example, comparator 340 may provide a high logic level to enable generator 350 and a low logic level to disable generator 350.

Although the scope of the present invention is not limited in this respect, the LQI may include at least one parameter indicating the quality of the link, for example the downlink 140, and at least one request for parameters to control the transportation of data over at least one selected channel. For example, generator 350 may receive from processor 320, the channel quality level of the received signal and data that may indicate a request for a parameter of a transport format of a data transmitted over the channel. Generator 350 may combine the channel quality level and the request, for example, a request to receive blocks of data at a predetermined rate, when providing the LQI. The request may be the transport format rate control (TFRC) which may include a modulating scheme, a coding scheme, the transport block size and the number of code channels. However, the LQI may include other parameters or requests then those that are described above. The LQI may then be provided to transmitter 360.

Although the scope of the present invention is not limited in this respect, transmitter 360 may include a modulator to modulate the LQI with a radio frequency (RF) signal, and a power amplifier (not shown) to transmit the modulated RF signal through at least one of the channels of uplink 120.

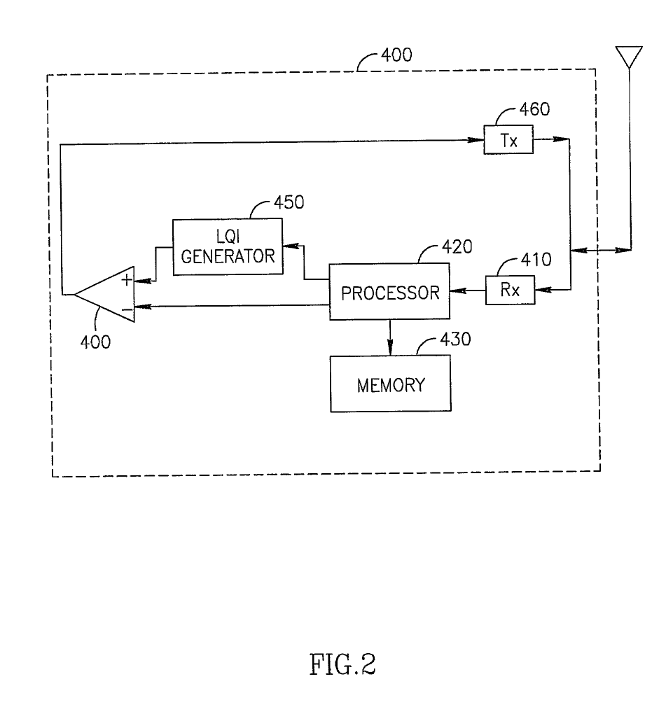

Although the scope of the present invention is not limited in this respect, base station 200 may receive the modulated RF signal by receiver 220. Receiver 220 may demodulate the signal, for example, with a WCDMA demodulator (not shown) or with another demodulator known to one skilled in the art. Furthermore, receiver 220 may decode the LQI from the demodulated signal and provide the LQI to processor 230. Processor 230 may read the LQI and in response may read from a memory 240 one or more parameters to control the transportation of the data and the voice over downlink 140. For example, the parameters may be a modulation scheme, the transport block size, the number of channels to use, and acoding scheme. In addition, base station 200 may transmit a target quality level (TQL) to mobile station 300. The target quality level may be used as the threshold for LQI. An alternative embodiment of the present invention such as, for example a mobile station and/or UE that may use the target quality level as a threshold level will be described below with reference to FIG. 2.

Turning to FIG. 2, a block diagram of a mobile communication UE 400 according to an alternative embodiment of the present invention is shown. In this example, UE 400 may be a WCDMA UE and may include a receiver 410, a processor 420, a memory 430, an LQI generator 450, a comparator 440 and a transmitter 460.

Although, it should be understood that the scope of the present invention is not limited in this respect, the operation and use of processor 420, LQI generator 450, comparator 440, transmitter 460 and receiver 410 was described above with reference to FIG. 1. One notable difference with this embodiment is that UE 400 may not adjust the threshold for the channel quality. For example, the threshold may be a predetermined value stored in memory 460 or may be received from a base station as a target quality level. In this example, receiver 410 may provide the target quality level to processor 420. Processor 420 may store the target quality level in memory 460 and may use it as a threshold to determine whether to transmit the LQI. If the LQI level is below or equal to the target quality level, comparator 440 may block the transmission of the LQI.

In another alternative embodiment of the present invention, the threshold level may be set to a fixed value. For example, the negative input of comparator 430 may be connected to a fixed voltage source.

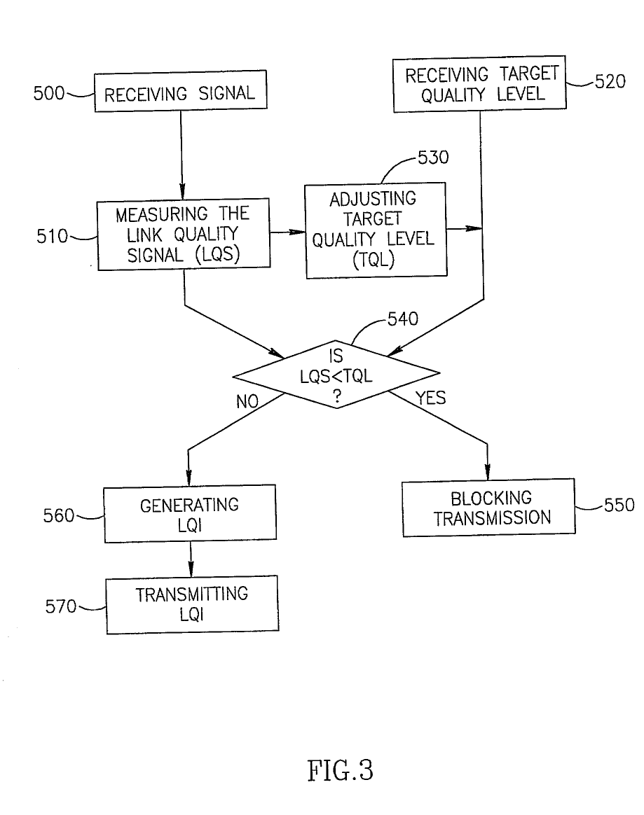

Tuning to FIG. 3, a flow chart of a method according to an embodiment of the present invention is shown. It should be understood to one skilled in the art that the method described below is an example only and other methods of blocking the transmission of the LQI may be used.

Although the scope of the present invention is not limited in this respect, the method may start with receiving a signal, for example by mobile station 300, over at least one of downlink 140 channels, for example a pilot channel, from a base station for example base station 200 of FIG. 1 (block 500). Mobile station 300 may perform measurement of characteristics of the received signal, or may estimate, based on the measurements, the quality of the channel (block 510). The parameters may be for example, BLER, SIR, SNR and the like. In addition, mobile station 300 may receive a target quality level from base station 200 (block 520), or may adjust the target quality level according to the measurements (block 540). The operation of adjusting the target quality level was described above with FIG. 1. Accordingly, mobile station 300 may compare the measured or estimated channel quality level with the target quality level (block 530), and may block the transmission of the LQI if the quality of the charnel is below the target quality level (block 550). However, in alternative methods of the present invention, the mobile station 200 may block the transmission of the LQI if the target quality level is equal to the channel quality level. If the channel quality level is above the target quality level, the mobile station 200 may generate the LQI (block 560). The generation of the LQI may involve combining a request to set a parameter of a transport format of a data transmitted over the channel with a parameter that may indicate the quality of the link. For example, a transport format may be modulating scheme of the transmitted data, the transport block size, the number of code channels (for WBCDMA) that may be used during the transmission or the modulating scheme, and the coding scheme that may be used during the transmission. Furthermore, the LQI may be generated according to a measured characteristics which may be BLER, SIR or SNR or the like. The LQI may be transmitted to base station 200 (block 570).

While certain features of the invention have been illustrated and described herein, many modifications, substitutions, changes, and equivalents will now occur to those of ordinary skill in the alt. It is, therefore, to be understood that the appended claims are intended to cover all such modifications and changes as fall within the true spirit of the invention.

What is claimed is:

1. A method comprising:
while transmitting, blocking transmission of a link quality indication if quality of a channel is below a target quality level.

2. The method of claim 1, further comprising:
adjusting the target quality level according to the quality of the channel.

3. The method of claim 2, further comprising:
receiving the target quality level over a downlink.

4. The method of claim 2, further comprising:
generating a request to receive a parameter of a transport format of data to be transmitted over one of the channel and another channel.

5. The method of claim 2, further comprising:
generating the link quality indication according to a measurement of a block error rate of a received signal received over a downlink.

6. The method of claim 5, wherein generating the link quality indication comprises:
combining a quality level of the downlink with a request to receive a parameter of a transport format of a data transmitted over one of the channel and another channel.

7. The method of claim 2, further comprising:
generating the link quality indication according to an estimation of the block error rate of a received signal received over a downlink.

8. The method of claim 2, further comprising:
generating the link quality indication according to a measurement of a signal to interference ratio of the received signal received over a downlink.

9. The method of claim 2, further comprising:
generating the link quality indication according to a measurement of a signal to noise ratio of the received signal received over a downlink.

10. A portable communication device comprising:
a comparator to block generation of a link quality indicator if a level of a measurement of a channel quality is below a target quality level.

11. The portable communication device of claim 10, further comprising:
a quality indication generator to generate the link quality indicator according to the measurement; and
a transmitter to transmit the link quality indicator if the measurement is above the target quality level.

12. The portable communication device of claim 10, further comprising:
a threshold generator to generate a threshold signal according to the target quality level.

13. The portable communication device of claim 10, further comprising:
a processor to provide the measurement of the channel quality.

14. The portable communication device of claim 11, wherein the threshold generator is able to adjust the threshold signal according to the measurement.

15. A portable communication device comprising:
a dipole antenna; and
a WCDMA receiver to receive a target quality level via the dipole antenna and to block transmission of a link quality indicator if quality of a channel is below a threshold.

16. The portable communication device of claim 15, further comprising:
a link quality indication generator to generate the link quality indicator according to a measurement of quality of the channel; and
a transmitter to transmit the link quality indicator if the measurement is above the threshold.

17. The portable communication device of claim 15, further comprising:
a threshold generator to generate the threshold according to the target quality level.

18. The portable communication device of claim 15, further comprising:
a threshold generator to adjust the threshold signal according to the measurement.

19. A system comprising:
user equipment to receive a target quality level indicating a target quality of a channel and to block transmission of a link quality indicator according to the target quality level.

20. The system of claim 19, wherein the user equipment comprises:
a processor to provide measurement of the channel; and
a comparator to block generation of the link quality indicator if the measurement is below or at a threshold to be generated according to the target quality level.

21. The system of claim 20, wherein the user equipment further comprises:
a quality indication generator to generate the link quality indicator according to the measurement; and
a transmitter to transmit the link quality indicator to the base station if the measurement is above the threshold.

22. The system of claim 19, wherein the link quality indicator comprises the quality level of a received signal.

23. The system of claim 20, wherein the threshold is to be adjusted according to the quality of the channel.

24. The system of claim 19, further comprising:
a base station to transmit the target quality level.

25. An article comprising a storage medium having stored thereon instructions that, when executed by a computing platform, result in:
blocking transmission of a link quality indication if quality of a channel is below a target quality level.

26. The article of claim 25, wherein the instructions further result in:
adjusting the target quality level according to the quality of the channel.

27. The article of claim 25, wherein the instructions further result in:
generating the link quality indication according to an mesurment of a block error rate of a received signal received over a downlink.

28. The article of claim 26, wherein the instructions of generating further result in:
combining a link quality level with a request to receive a parameter of a transport format of data to be transmitted over the channel.

29. The article of claim 25, wherein the instructions further result in:
generating the link quality indication according to an estimation of a block error rate of a received signal received over a downlink.

30. The article of claim 26, wherein the instructions further result in:
generating the link quality indication according to an estimation of a signal to interference ratio of a received signal received over a downlink.

31. The article of claim 25, wherein the instructions further result in:
generating the link quality indication according to an estimation of a signal to noise ratio of a received signal.
